(19) United States
(12) Patent Application Publication
(10) Pub. No.: US 2006/0171326 A1
(43) Pub. Date: Aug. 3, 2006

(54) Remedial actions for interference in wireless LANs

(75) Inventors: Roger Durand, Amherst, NH (US); Michael Yuen, Waltham, MA (US)

Correspondence Address: McGUINNESS & MANARAS LLP, 125 NAGOG PARK, ACTON, MA, 01720, US

(73) Assignee: Autocell Laboratories, Inc.

(21) Appl. No.: 11/103,408

(22) Filed: Apr. 11, 2005

Related U.S. Application Data
(60) Provisional application No. 60/649,799, filed on Feb. 3, 2005.

(51) Int. Cl. H04L 1/00

(52) U.S. Cl. 370/252

(57) ABSTRACT

In a wireless network having an access point and at least one wireless end device, the access point is operable to differentiate between normal communications and interference from another device in order to capture a sample of the interference, determine whether the interference originates from a known type of device, and prompt remedial actions such as moving communications to a distant channel, increasing transmission power, changing data rate, and packet fragmentation based on whether the interference originates from a known type of device. Interference pulse duration may be used to at least initially narrow the possible sources of interference. Pulse period may be employed to differentiate between interference sources which exhibit similar pulse duration. If pulse duration and period are not sufficient to identify the interference source then other characteristics may be examined, such as pulse waveform, roll off and period in relation to local power frequency. In the case of microwave interference it is generally best to move to a distant channel. Increased transmission power and packet fragmentation can be used to maintain communications while scanning for a new channel.

### CROSS-REFERENCE TO RELATED APPLICATIONS

A claim of priority is made to U.S. Provisional Patent Application Ser. No. 60/649,799, entitled Interference Counter Measures for Wireless LANs, filed Feb. 3, 2005, which is incorporated herein by reference.

### FIELD OF THE INVENTION

This invention is generally related to wireless communications, and more particularly to coping with interference in a wireless communications network.

### BACKGROUND OF THE INVENTION

Certain wireless local area network (“WLAN”) products, such as products based on the IEEE 802.11 standard, operate in unregulated spectrum. One problem associated with operating in unregulated spectrum is the potential of encountering interference from other devices. Regulated spectrum is relatively free of interference because unlicensed products which operate in the regulated spectrum can be removed from the marketplace. Even in unregulated spectrum there is at least a possibility of negotiating strategies for coping with interference from standards-compliant devices via standards organizations. However, some of the potential interfering devices are not standards-compliant, and some are not even communications devices. There is therefore a need for techniques and devices for coping with interference in unregulated spectrum.

### SUMMARY OF THE INVENTION

In accordance with the invention, in a wireless network having an access point and at least one wireless end device, a method for coping with interference from another device that adversely effects communications between the access point and the end device includes the steps of: identifying the interference signal; if the interference signal exhibits a pulse waveform, determining pulse duration; and selecting a remedial action based at least in-part on pulse duration. Remedial actions include but are not limited to increasing signal power, moving communications to an alternate channel, using packet fragmentation, and combinations thereof, collectively “counter measures.” Counter measures may include combinations of remedial actions arranged hierarchically such that a secondary action is executed if the primary action is not sufficiently effective. Further, secondary characteristics such as error rate and interference pulse period may be employed to select specific counter measures within a given range of interference pulse duration.

The invention helps improve communications by facilitating selection of an appropriate counter measure for the particular interference encountered. Different interference sources may have significantly different effects on communications with a spectrum. For example, some interference sources are relatively localized to a particular channel, whereas other interference sources adversely effect multiple channels. Similarly, some interference sources exhibit relatively higher power, longer pulse duration, or longer pulse period. Hence, particular remedial actions are not equally effective against all interference sources. While it might be possible to attempt various remedial actions, the delay associated with finding an effective action could be disruptive to communications. By analyzing the interference signal the present invention enables quicker implementation of a more effective remedial action, and hence tends to reduce the delay and associated disruption of communication. Further, by characterizing an interference source without necessarily examining every characteristic of the interference signal it is possible to realize savings in processing power and sampling time.

### BRIEF DESCRIPTION OF THE FIGURES

FIG. 1 illustrates a wireless access point and end station adapted for coping with interference.

FIG. 2 is a flow diagram illustrating a technique for coping with interference.

FIG. 3 illustrates aspects of an interference waveform.

FIG. 4 illustrates selection and implementation of counter measures in greater detail.

FIG. 5 illustrates packet fragmentation.

### DETAILED DESCRIPTION

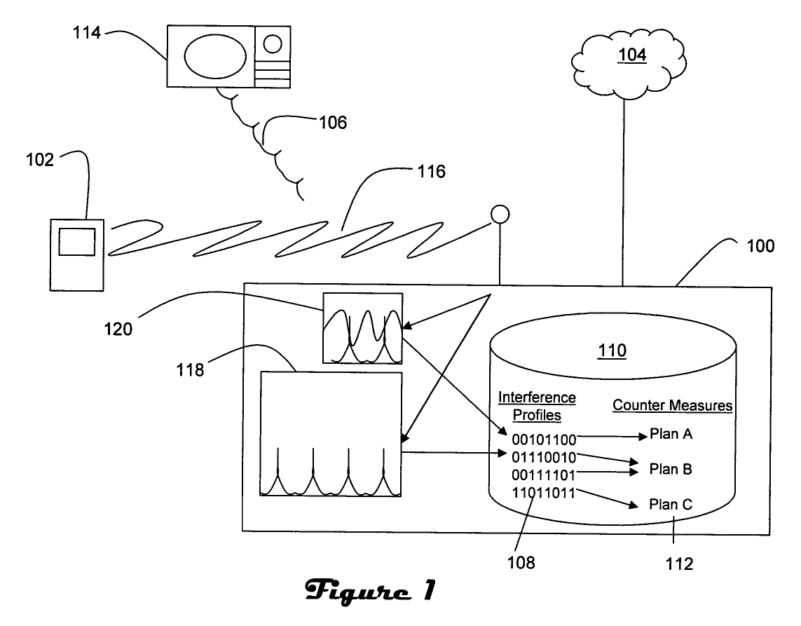

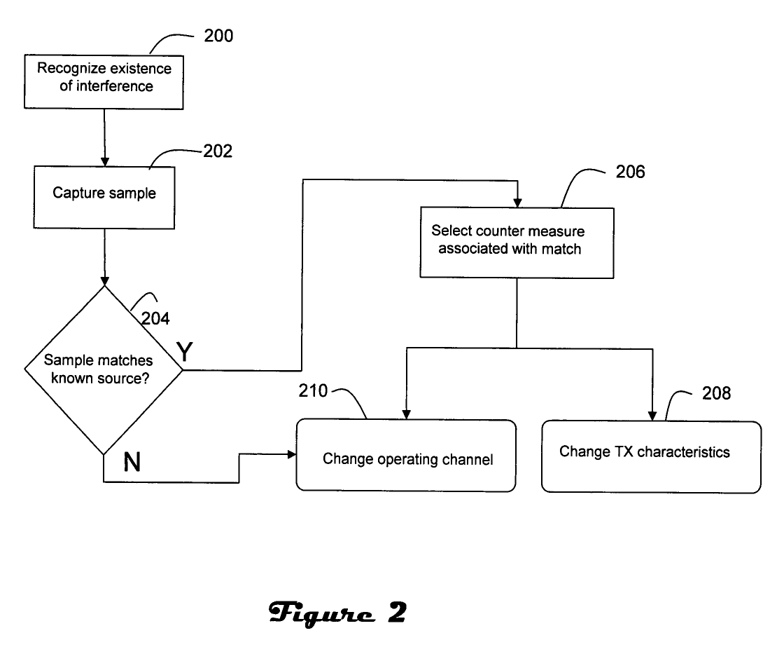

Referring to FIGS. 1 and 2, a wireless access point (100) is operative to provide network access to a wireless end station (102) such as a personal computer, PDA, notebook computer or phone. The end station (102) is typically a mobile device without wireline connections, whereas the access point (100) is typically a stationary device having a wireline connection with another network device such as switch, router or server in a network (104). Communications between the access point (100) and the end station (102) are typically two-way, and may utilize one or more channels within a predefined spectrum.

The access point (100) is adapted to recognize and respond to interference (106) generated by a device (114) other than the end station (102). For example, the access point includes a table (108) of interference profiles in memory (110) which are indicative of particular sources of interference. The memory (110) also includes a table (112) of counter measure plans which specify actions to be taken when a particular source of interference is recognized. Each counter measure plan specifies at least one remedial action, such as altering transmission characteristics and changing to an alternate communication channel. The remedial actions may be arranged hierarchically such that multiple actions are attempted in a predefined order until a satisfactory result is obtained. Each interference profile in the table (108) is associated with at least one counter measure plan in the corresponding table (112), and multiple interference profiles may be associated with a particular counter measure plan.

The first step (200) in the technique employed by the access point (100) to cope with interference is recognizing the existence of the interference (106). The access point may recognize the interference by analyzing the signal received at the access point. For example, a quiet interval may be implemented such that the signal received at the access point does not include normal traffic (116) between the access point and end station, but rather comprises any existing interference, e.g., signal (106). An alternative to use of the quiet interval is to analyze the combination of normal traffic signal (116) and interference signal (106). For example, a parallel demodulation engine (120) may be programmed to identify, from the combined signal, types of interference that differ recognizably from actual data in the channel. Alternatively, recognition of a combined signal which has a relatively high proportion of noise or is not in a format specified by the communications protocol being utilized may be used as an indication of the presence of interference. Alternatively, some communications protocols specify use of periodic communications between an access point and end station primarily to verify that the communications link is operational. Such a protocol may also be used to recognize the existence of interference when the communications link fails for purposes of the present technique.

Once the access point recognizes the existence of interference it then captures a sample (118) of the interference as indicated in step (202) in order to attempt to identify the source of the interference. The sample may be captured by storing a portion of the interference signal (106) received at the access point. The received signal, which is analog, may then be sampled and converted to digital format for processing. Each sample measurement is associated with a time stamp indicating the relative time at which the sample was obtained. Hence, the resulting data comprises sets of energy magnitude measurements and time stamps.

Because there are different possible sources of interference, and the characteristics of the interference associated those sources may vary, the sampling rate and period are selected to capture a sufficient sample to identify all known potential sources of interference stored in the digital patterns in memory. The sample (118) is then compared with the interference profiles in table (108) to identify a match, or the absence of a match, as indicated by step (204). Alternatively, an adaptive algorithm may be employed to adjust the sampling period and rate until a match between the sample and an interference profile is located or eliminated as a possibility. If a matching interference profile is located in table (108) then the associated counter measures plan is selected as indicated by step (206). As discussed above, the counter measures plan may include one or both of changing transmission signal characteristics as indicated by step (208) and changing to an alternate operating channel as indicated by step (210). If no matching interference profile is located then the access point changes to the alternate operating channel as indicated by step (210).

The quiet interval may be implemented by various techniques. For example, a continuous quiet interval may be implemented by temporarily ceasing communications until a sample of sufficient duration is obtained. Alternatively, temporally non-contiguous quiet gaps between communications may be combined via a relatively long sampling window during which the probability of having a continuously occupied channel over the entire time period is near zero to assemble a quiet interval.

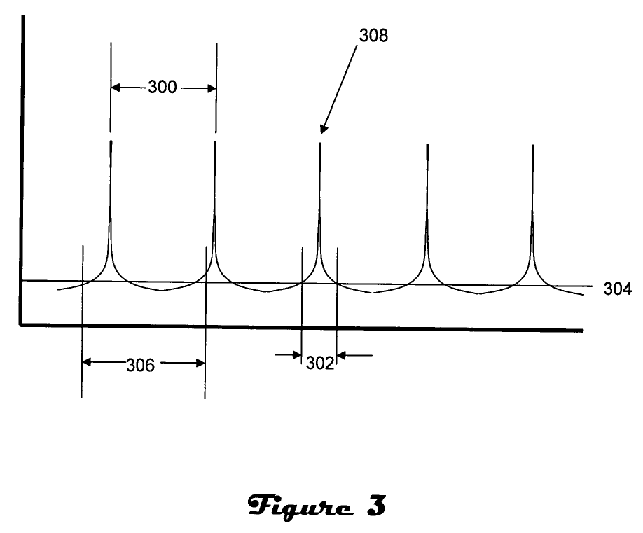

Referring to FIGS. 1 and 3, the samples (118) are primarily characterized in terms of pulse duration (302), although pulse period (300) may also be employed to differentiate between interference sources. Pulse period (300) is indicative of the time between consecutive pulses, and pulse duration (302) is indicative of the time during which an individual pulse exhibits a power level above a predetermined threshold, i.e., sampling noise floor (304). After gathering multiple data points across a sample window (306), parallel processes are executed to calculate interference signal duration and period. Initially, the point of maximum energy (“peak”) (308) in the sample window is identified. Once the peak is identified, an energy level “time width” on either side of the peak energy point is identified by finding the first samples on both sides that drop to the measurement noise floor (304) on each side of the peak (308). Contemporaneously with the interference duration calculation an interference signal period calculation is executed by identifying corresponding peaks, and then calculating the time between consecutive peaks.

The technique described above for representing pulse interference sources will now be described with respect to a specific example. Given a microwave oven at 2 meters distance, with peak energy in the channel at −24 dBm, a peak energy point P1 occurs at a time T1 (time=0 Sec). The energy attributable to the microwave drops below a noise floor of −81 dBm between successive energy peaks. Having collected data for a predefined window, the energy values are compared in order to identify the highest value, P1, T1. The samples preceding P1, T1 are then parsed until a sample at P0, T0 (time=−3.7 mSec) with energy value below the noise floor is located. The samples following P1, T1 are also parsed until a sample P2, T2 (time=3 mSec) with energy value below the noise floor is located. The pulse duration is determined by calculating the time between T0 and T2, which is 6.7 mSec. The accuracy of the technique may be modified by interpolation or dithering. For example, because the samples at T0 and T2 may not have the exact energy values as the noise floor, as interpolation between sample on either side of the noise floor can be employed to enhance accuracy. The pulse period is determined by calculating the time between consecutive energy peaks, i.e., T1₂-T1₁. Consecutive peaks may be identified by searching the collected samples for samples having higher energy values than the samples immediately preceding and following. Spurious samples and secondary interference sources may be filtered by using only consecutive peaks within a predetermined range. For example, if a first detected peak has energy value xdBm then only other peaks having energy value X+/−10 dBm are considered to be related peaks. Alternatively, or in addition to the energy level comparison, more than two consecutive peaks may be compared to determine that the pulse period is constant. Any peaks which fall outside the pulse period constant by greater than a predetermined value are discarded. Again, interpolation and dithering techniques may be employed to increase accuracy.

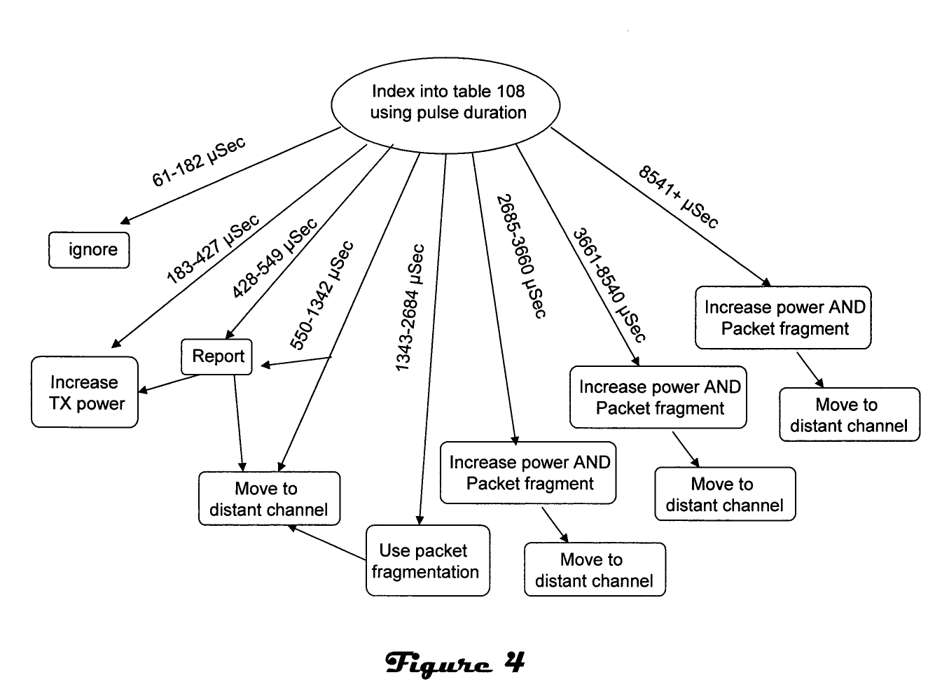

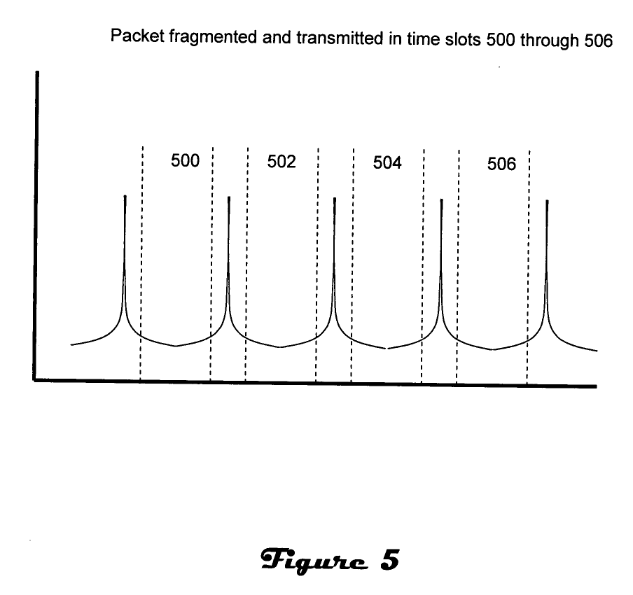

Referring now to FIGS. 1, 4 and 5, the pulse duration of the sample (118) is employed as an index into table (108). Table (108) characterizes different interference sources in terms of pulse duration, although pulse period may also be employed. If the pulse duration is in the range of 61-182 μSec then the counter measure plan in table (112) specifies that the interference be ignored. There is a probability that interference characterized by this pulse duration range is a result of switching transients internal to the access point (100).

If the pulse duration is in the range of 183-427 μSec then the counter measure plan in table (112) specifies that signal transmission power be increased. In particular, the access point (100) increases the power of the signals which it transmits. The access point may also signal to the end station (102) to prompt the end station to increase signal transmission power. An interference pulse duration in the range of 183-427 μSec is indicative of a Bluetooth product. Bluetooth products operate at relatively low power levels throughout the 2.4 GHz band. Hence, increasing transmission power is generally more effective at mitigating the effects of the interference than changing channels. Because relatively lower power Bluetooth products have little negative impact on orthogonal frequency division multiplexing (“OFDM”) communications, the power increase may be made contingent upon transmission errors being greater than a predetermined threshold.

If the pulse duration is in the range of 428-549 μSec then the counter measure plan in table (112) specifies that the condition is reported. In particular, the pulse duration and peak power level are reported to control software executed by the access point. Interference exhibiting a pulse duration in this range may be from a Bluetooth product or a short-sync pulse from a FHSS cordless phone base station. If transmission errors exceed a predetermined threshold because of interference in this range then the control software may prompt active remedial actions. For example, if transmission errors exceed the threshold and it is possible to differentiate between a Bluetooth product and FHSS cordless phone as the source then power is increased in the case of a Bluetooth product, whereas transmission is moved to a distant channel in the case of the FHSS cordless phone.

If the pulse duration is in the range of 550-1342 μSec then the counter measure plan in table (112) specifies that communications are moved to a distant channel. An interference source exhibiting a pulse duration within this range is likely a FHSS cordless phone, although it may also be a microwave source on an adjacent or more distant channel. The sample (118) may be examined more closely to distinguish between the microwave and FHSS cordless phone. In the case of the FHSS cordless phone the peak is relatively flat and the pulse duration is in the range of 625-950 μSec, increasing in proportion to the number of handsets. Conversely, if the peak rolls off in power more than 5 dB the source is probably microwave, particularly if the pulse duration is at the higher part of the range. If the interference source is determined to be a FHSS cordless phone then the condition may simply be reported. However, if the source is microwave then steps may be taken to determine the channel on which the microwave is operating and then move to a distant channel.

If the pulse duration is in the range of 1343-2684 μSec then the counter measure plan in table (112) specifies that packet fragmentation is employed. In order to employ packet fragmentation the pulse duration and pulse period are employed to identify recurring time slots between peaks during which the channel is clear of interference. Transmissions are then made inside those time slots, and ceased outside the time slots. In order to accommodate relatively short duration time slots it may be necessary to segment packets such that a single packet is transmitted via multiple time slots, e.g., time slots (500), (502), (504) and (506) used to transmit a single packet. An interference source exhibiting a pulse duration within this range is likely a microwave on an adjacent channel. Pulse period may be employed to obtain data further supporting identification of the source as microwave. In particular, a single pulse microwave fires once every AC cycle whereas a double pulse microwave fires twice every AC cycle. Hence, local power standards and the measured pulse period can be employed to produce corroborating data. If fragmentation is not sufficiently effective, communications may be moved to a distant channel.

If the pulse duration is in the range of 2685-3660 μSec then the counter measure plan in table (112) specifies that power is increased and packet fragmentation is employed, following which communications may be moved to a distant channel. An interference source exhibiting a pulse duration within this range can be a microwave that is straddling the channel if it is single pulse, or a microwave in the channel if it is double pulse.

If the pulse duration is in the range of 3661-8540 μSec then the counter measure plan in table (112) specifies that power is increased and packet fragmentation is employed, following which communications may be moved to a distant channel. An interference source exhibiting a pulse duration within this range is most likely a single pulse microwave in channel. Generally, moving communications to a more distant channel is an effective counter measure for microwave interference.

If the pulse duration is above 8541 μSec then the counter measure plan in table (112) specifies that power is increased and packet fragmentation is employed. If those steps are not sufficiently effective then communications may be moved to a distant channel. An interference source exhibiting a pulse duration within this range is a CW interferer such as a video camera, cordless phone, or video delivery system.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. In a wireless network having an access point and at least one wireless end device, a method for coping with interference from another device that adversely effects communications between the access point and the end device comprising the steps of:
identifying the interference signal;
if the interference signal exhibits a pulse waveform, determining pulse duration; and
selecting a remedial action based at least in-part on pulse duration.

2. The method of claim 1 comprising the further step of ignoring the interference if the pulse duration is in the range of 61-182 μSec.

3. The method of claim 1 comprising the further step of increasing transmission power is the pulse duration is in the range of 183-427 μSec.

4. The method of claim 3 comprising the further step of increasing transmission power contingent upon transmission errors being greater than a predetermined threshold.

5. The method of claim 1 comprising the further step of reporting peak interference signal power if the pulse duration is in the range of 428-549 μSec.

6. The method of claim 5 comprising the further steps of, if transmission errors exceed a predetermined threshold and it is possible to differentiate between a Bluetooth product and FHSS cordless phone as the source of interference, increasing transmission power in the case of a Bluetooth product and moving to a distant channel in the case of the FHSS cordless phone.

7. The method of claim 1 comprising the further step of moving communications to a distant channel if the pulse duration is in the range of 550-1342 μSec.

8. The method of claim 7 comprising the further steps of distinguishing between a microwave and FHSS cordless phone as the interference source, and if the interference source is determined to be a FHSS cordless phone then reporting peak interference signal power, and if the source is microwave then determining which channel has greatest interference from the microwave and then moving communications to a distant channel relative to the channel of greatest interference.

9. The method of claim 1 comprising the further step of employing packet fragmentation if the pulse duration is in the range of 1343-2684 μSec.

10. The method of claim 9 comprising the further step of using interference pulse duration and pulse period to identify recurring time slots between peaks during which the channel is clear of interference.

11. The method of claim 10 comprising the further step of transmitting data only inside those time slots.

12. The method of claim 11 comprising the further step of segmenting packets such that a single packet is transmitted via multiple time slots.

13. The method of claim 12 comprising the further step of moving communications to a distant channel if fragmentation is not sufficiently effective.

14. The method of claim 1 comprising the further steps of increasing transmission power and employing packet fragmentation if the pulse duration is in the range of 2685-3660 μSec.

15. The method of claim 14 comprising the further steps of identifying an alternate channel and moving communications to the identified channel.

16. The method of claim 1 comprising the further steps of increasing transmission power and employing packet fragmentation if the pulse duration is in the range of 3661-8540 μSec.

17. The method of claim 16 comprising the further steps of identifying an alternate channel and moving communications to the identified channel.

18. The method of claim 1 comprising the further steps of increasing transmission power and employing packet fragmentation if the pulse duration is above 8541 μSec.

19. The method of claim 18 comprising the further step of moving communications to a distant channel if increasing transmission power and employing packet fragmentation are not sufficiently effective.

20. In a wireless network having an access point and at least one wireless end device, apparatus for coping with interference from another device that adversely effects communications between the access point and the end device comprising:
processing logic operable to identify the interference signal;
processing logic operable to determine pulse duration if the interference signal exhibits a pulse waveform; and
processing logic operable to select at least one counter measure from memory based at least in-part on pulse duration.

21. The apparatus of claim 20 further comprising the counter measure of ignoring the interference if the pulse duration is in the range of 61-182 μSec.

22. The apparatus of claim 20 further comprising the counter measure of increasing transmission power is the pulse duration is in the range of 183-427 μSec.

23. The apparatus of claim 22 further comprising the counter measure of increasing transmission power contingent upon transmission errors being greater than a predetermined threshold.

24. The apparatus of claim 20 further comprising the counter measure of reporting peak interference signal power if the pulse duration is in the range of 428-549 μSec.

25. The apparatus of claim 24 further comprising the counter measures of, if transmission errors exceed a predetermined threshold and it is possible to differentiate between a Bluetooth product and FHSS cordless phone as the source of interference, increasing transmission power in the case of a Bluetooth product and moving to a distant channel in the case of the FHSS cordless phone.

26. The apparatus of claim 20 further comprising the counter measure of moving communications to a distant channel if the pulse duration is in the range of 550-1342 μSec.

27. The apparatus of claim 26 further comprising processing logic operable to distinguish between a microwave and FHSS cordless phone as the interference source, and further comprising the counter measures of reporting peak interference signal power if the interference source is determined to be a FHSS cordless phone, and processing logic operable to determine which channel has greatest interference in the case of the microwave and the counter measure of moving communications to a distant channel relative to the channel of greatest interference if the source is microwave.

28. The apparatus of claim 20 further comprising the counter measure of employing packet fragmentation if the pulse duration is in the range of 1343-2684 μSec.

29. The apparatus of claim 28 further comprising processing logic operable to use interference pulse duration and pulse period to identify recurring time slots between peaks during which the channel is clear of interference.

30. The apparatus of claim 29 further comprising the counter measure of transmitting data only inside those time slots.

31. The apparatus of claim 30 further comprising processing logic operable to segment packets such that a single packet is transmitted via multiple time slots.

32. The apparatus of claim 31 further comprising the counter measure of moving communications to a distant channel if fragmentation is not sufficiently effective.

33. The apparatus of claim 20 further comprising the counter measures of increasing transmission power and employing packet fragmentation if the pulse duration is in the range of 2685-3660 μSec.

34. The apparatus of claim 33 further comprising processing logic operable to identify an alternate channel and the counter measure of moving communications to the identified channel.

35. The apparatus of claim 20 further comprising the counter measures of increasing transmission power and employing packet fragmentation if the pulse duration is in the range of 3661-8540 μSec.

36. The apparatus of claim 35 further comprising processing logic operable to identify an alternate channel and the counter measure of moving communications to the identified channel.

37. The apparatus of claim 20 further comprising the counter measures of increasing transmission power and employing packet fragmentation if the pulse duration is above 8541 μSec.

38. The apparatus of claim 37 further comprising the counter measure of moving communications to a distant channel if increasing transmission power and employing packet fragmentation are not sufficiently effective.
